(19) United States
(12) Patent Application Publication
(10) Pub. No.: US 2021/0041622 A1
(43) Pub. Date: Feb. 11, 2021

(54) Multicore Fiber and Manufacturing Device Therefor

(71) Applicant: Nippon Telegraph and Telephone Corporation, Tokyo (JP)

(72) Inventors: Hirotaka Ono, Tokyo (JP); Shinichi Aozasa, Tokyo (JP)

(21) Appl. No.: 16/963,455

(22) PCT Filed: Feb. 8, 2019
(86) PCT No.: PCT/JP2019/004633

§ 371 Date: Jul. 20, 2020

(30) Foreign Application Priority Data
Feb. 8, 2018 (JP) 2018-021422

(51) Int. Cl. G02B 6/02; C03C 25/12; C03C 25/1065

(52) U.S. Cl. CPC G02B 6/02042; C03C 25/1065; C03C 25/12

(57) ABSTRACT

Provided are a multi-core fiber that enables complete automation of alignment in fusion splicing of multi-core fibers and an apparatus for manufacturing the multi-core fiber. A glass cladding of the multi-core fiber has a coating. A coating marker is drawn on the coating at a position that is determined by a predetermined rule that prescribes a positional relation with the core, for example, the coating marker is drawn on the coating near a specific core number. During fusion splicing of the multi-core fibers, two multi-core fibers are installed such that positions of the coating markers are substantially aligned. After the installation of the multi-core fibers, the coating markers of the two multi-core fibers are subjected to automatic rotational alignment by a fusion splicer to achieve a predetermined positional relation, and thus rotational positions between the two multi-core fibers are aligned.

### TECHNICAL FIELD

The present invention relates to a multi-core fiber used for optical communication and an apparatus for manufacturing the same.

### BACKGROUND ART

In order to significantly increase transmission capacity of an optical transmission system, development of a multi-core optical transmission system has been advanced in which a multi-core fiber including a plurality of cores in one fiber is used for a transmission line. In the multi-core optical transmission system, since a wavelength division multiplexing (WDM) signal for transmitting different information is propagated to respective cores of the multi-core fiber, the transmission capacity can be significantly increased compared to a case in which a conventional single core fiber including one core in one fiber is used for a transmission line.

FIG. 1 shows an example of a cross section of a conventional multi-core fiber. The multi-core fiber shown in FIG. 1 is a seven-core fiber, and seven cores 902 are arranged in a cladding 901. In addition, a marker 903 serving as a reference is arranged so as to associate cores with core numbers (denoted by a symbol # in the drawing).

In order to perform fusion splicing on two multi-core fibers, end faces of both fibers are observed and alignment is performed in a rotation direction of a cross section (see Non-Patent Literature 1). The alignment in the rotation direction of the cross section, that is, rotational alignment is automatically performed by photographing a cross section of the fiber, checking a core geometry in the cross section of the fiber using image recognition technology, and operating a motor of a fusion splicer so that positions of the respective cores 902 (#0 to #6) match each other. In addition, images obtained by observing the fiber from the side can be automatically performed using image recognition technology in alignment in two directions (X direction and Y direction) orthogonal to each other in the cross section of the fiber. In other words, when two multi-core fibers are installed in the fusion splicer, subsequent alignment can be automatically performed.

Here, since the core 902 has a larger contrast than the cladding 901 in the rotational alignment, the position thereof can be grasped in image recognition.

### CITATION LIST

### Non-Patent Literature

Non-Patent Literature 1: Y. Amma et al., “Accuracy of core alignment with end-view function for multicore fiber,” 2014 IEEE Photonics Society Summer Topical Meeting Series (SUM2014) on Space-Division Multiplexing Technologies for High Capacity Transmission (SDMT), pp. 170-171

### SUMMARY OF THE INVENTION

### Technical Problem

However, there are problems that the marker 903 has a smaller contrast than the cladding 901 and the position thereof can hardly be grasped by the conventional technology. Therefore, the alignment with matching of the core numbers #0 to #6 cannot be performed in the automatic rotational alignment using the conventional image recognition technology. In other words, there are problems that fusion splicing by matching of the core numbers #0 to #6 needs to perform automatic alignment using image recognition technology after a person checks positions between the markers in the rotation direction on an end face image of the fiber and manually sets an offset angle for the rotational alignment and complete automation alignment of two fibers can hardly be performed.

The present invention has been made in view of such circumstances, and an object thereof is to provide a multi-core fiber that enables complete automation of alignment in fusion splicing of multi-core fibers and an apparatus for manufacturing the multi-core fiber.

### Means for Solving the Problem

In order to solve the problems, a multi-core fiber according to one embodiment of the present invention includes: a cladding, a plurality of cores being arranged in the same cladding; and a coating, a marker being drawn on the coating.

In another embodiment, the marker is drawn linearly in a longitudinal direction of the multi-core fiber.

In further another embodiment, the coating is a double coating including an inner coating and an outer coating, and the marker is drawn on the inner coating.

An apparatus for manufacturing the multi-core fiber according to one embodiment of the present invention includes: a heating furnace; a fiber diameter monitor; a coating resin film forming unit; a coating resin UV curing unit; and a winding unit, the apparatus further comprising a unit configured to draw a coating marker on a coating formed by the coating resin film forming unit.

In another embodiment, the unit configured to draw the coating marker includes two coating marker capstans arranged to face each other so as to sandwich the multi-core fiber, and a coating material is applied to an outer peripheral surface of at least one of the coating marker capstans to draw the coating marker.

In further another embodiment, the coating resin film forming unit includes a first coating resin film forming unit and a second coating resin film forming unit, the coating resin UV curing unit includes a first coating resin UV curing unit and a second coating resin UV curing unit, and the unit configured to draw the coating marker is arranged between a set of the first coating resin film forming unit and the first coating resin UV curing unit and a set of the second coating resin film forming unit and the second coating resin UV curing unit.

### Effects of the Invention

It is possible to perform complete automation of alignment in fusion splicing of multi-core fibers using the multi-core fiber and the apparatus for manufacturing the same of the present invention.

### BRIEF DESCRIPTION OF DRAWINGS

FIG. 1 is a diagram showing an example of a cross section of a conventional multi-core fiber.

FIG. 2 is a schematic diagram of a multi-core fiber according to a first embodiment of the present invention.

FIG. 3 is a diagram showing an arrangement relation during fusion splicing of two multi-core fibers of the present invention.

FIG. 4 is a diagram showing a configuration example of an apparatus for manufacturing the multi-core fiber according to the first embodiment of the present invention.

FIG. 5(a) is a diagram showing a configuration example of a coating marker drawing unit 110 for the multi-core fiber of the present invention, and FIG. 5(b) is a diagram showing an example of a structure for applying a coating marker 10 in the coating marker drawing unit 110.

FIG. 6 is a schematic diagram of a multi-core fiber according to a second embodiment of the present invention.

FIG. 7 is a diagram showing a configuration example of an apparatus for manufacturing the multi-core fiber according to the second embodiment of the present invention.

### DESCRIPTION OF EMBODIMENTS

Embodiments of the present invention will be described below.

### First Embodiment

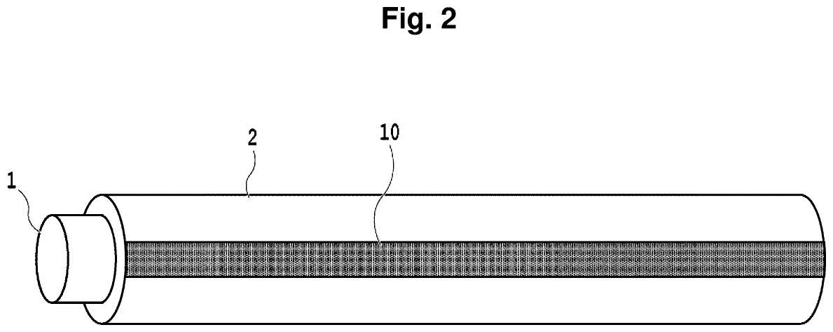

FIG. 2 is a schematic diagram of a multi-core fiber according to a first embodiment of the present invention. The multi-core fiber according to the first embodiment of the present invention shown in FIG. 2 has a configuration in which a resin coating 2 is coated on a circumference of a glass cladding 1 in which a plurality of cores are arranged. On the coating 2, a coating marker 10, which is a feature of the present invention, is drawn. In FIG. 2, a plurality of cores arranged in the glass cladding 1 and markers for rotational alignment are not shown.

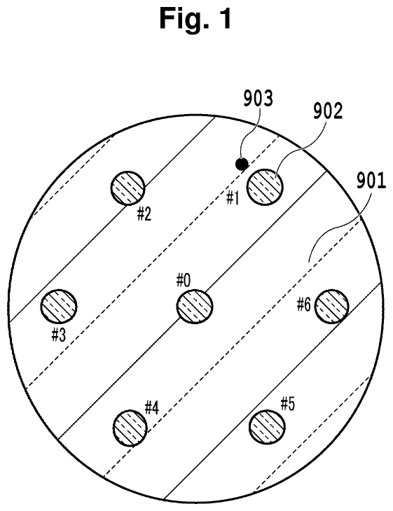

The coating marker 10 may be drawn at a position determined by a predetermined rule that prescribes a positional relation with the core; for example, the coating marker is drawn on the coating near a specific core number (for example, a core #1 in FIG. 1), and is not limited to an example shown in FIG. 2. Note that the coating marker 10 shown in FIG. 2 has a liner shape extending in a longitudinal direction of the multi-core fiber, but the coating marker 10 may have any shape as long as a positional relation with each core arranged around a central axis of the multi-core fiber can be determined.

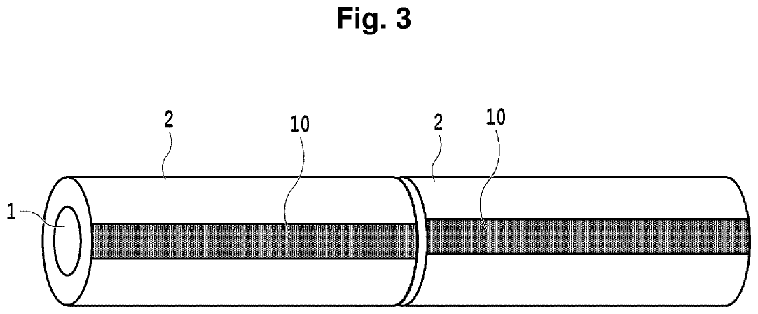

First, as shown in FIG. 3, during fusion splicing of the multi-core fibers of the present invention, two multi-core fibers are installed such that positions of the coating markers 10 are substantially aligned. After the installation of the multi-core fibers, the coating markers 10 of the two multi-core fibers are subjected to automatic rotational alignment by a fusion splicer to achieve a predetermined positional relation, and thus rotational positions between the two multi-core fibers are aligned. When the positional relation between the positions of the coating markers 10 of the two multi-core fibers and the cores are the same, the coating markers 10 are aligned to match each other and thus core numbers of the two multi-core fibers are aligned to match each other. In addition, when the coating markers 10 are aligned by rotation with a predetermined angle, splicing can also be performed in a state where the core numbers are shifted. When the multi-core fiber of the present invention is used as described above, complete automation alignment can be performed using a fusion splicer.

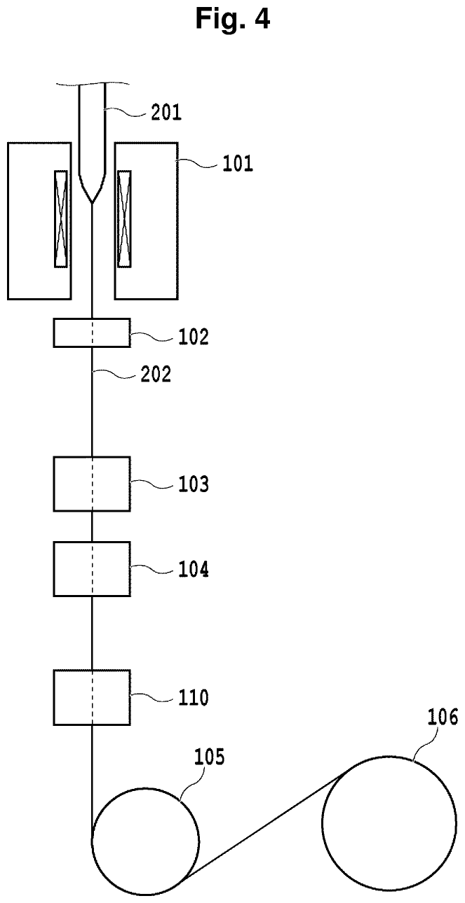

FIG. 4 shows a configuration example of a manufacturing apparatus of the multi-core fiber according to the first embodiment of the present invention. A preform 201, which is a preform of a multi-core fiber manufactured in advance, is heated with a heating furnace 101 to be stretched into a thread shape, and a temperature of the heating furnace 101 is adjusted so that the preform has a predetermined diameter by a fiber diameter monitor 102. A stretched multi-core fiber 202 is coated with a resin in a coating resin film forming unit 103, and the resin is cured by irradiation with ultraviolet rays in a coating resin UV curing unit 104. A coating marker drawing unit 110 draws a marker on the cured coating. A multi-core fiber 202, on which the marker is drawn, is wound by a winding unit 106 via a capstan 105.

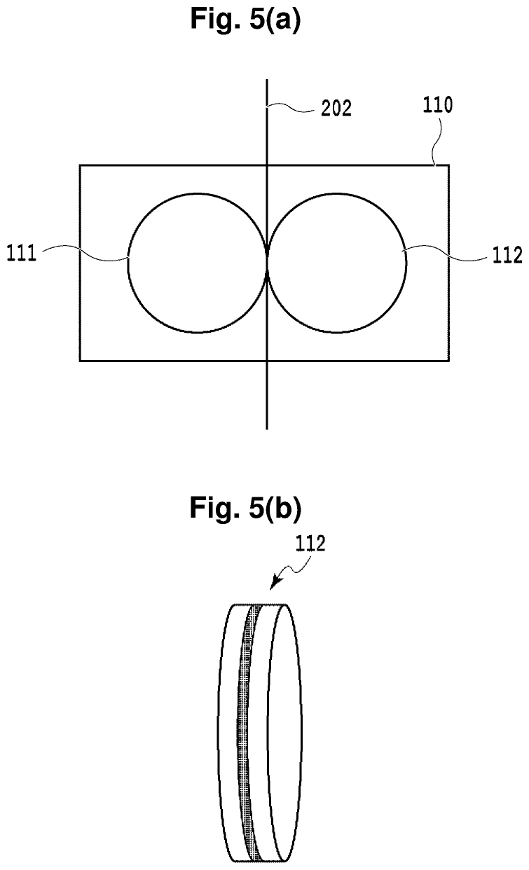

FIGS. 5(a) and 5(b) show an example of the coating marker drawing unit 110 for the multi-core fiber of the present invention. In this example, the multi-core fiber 202 is sandwiched between two capstans 111 and 112 (see FIG. 5(a)), and a structure (see FIG. 5(b)) for applying the coating marker 10 to one of the capstans (to the capstan 112 herein) is incorporated. In other words, a structure in which a coating material of the coating marker 10 is applied to an outer peripheral surface of the capstan 112 contacting with the multi-core fiber 202 is incorporated. When the coated multi-core fiber 202 passes through a portion sandwiched between the two capstans 111 and 112, the coating marker 10 is drawn.

Since the coating marker drawing unit 110 only needs to be able to draw a marker at a predetermined position with respect to each of cores arranged around the central axis of the multi-core fiber 202, a brush or an inkjet for spraying a coating material may be used instead of the capstan 112 to which a coating material is applied.

An example of the coating material of the coating marker 10 may include an oil-based acrylic resin coating material that does not easily peel off after being applied to the coating.

### Second Embodiment

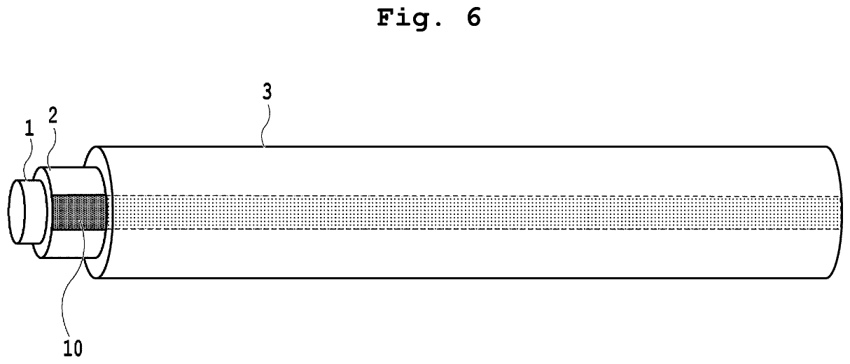

FIG. 6 is a schematic diagram of a multi-core fiber according to a second embodiment of the present invention. The multi-core fiber according to the second embodiment of the present invention shown in FIG. 6 has a configuration in which resin inner coating 2 and outer coating 3 are double-coated on a circumference of a glass cladding 1 in which a plurality of cores are arranged.

A coating marker 10 is a coating marker which is a feature of the present invention and is drawn on the coating, and is drawn on the inner coating 2. In FIG. 6, the plurality of cores arranged in the glass cladding and markers for rotational alignment are not shown. The coating marker 10 is the same as that of the multi-core fiber described in the first embodiment in terms of being drawn at the position that is determined by the core position and a predetermined rule.

The outer coating 3 is made of a material that becomes transparent after UV curing. Thereby, the coating marker 10 drawn on the inner coating 2 is made visible.

With such double coatings, a cladding mode is effectively eliminated using a member with a higher refractive index than that of the glass cladding 1 for the inner coating 2 that is in contact with the glass cladding 1, and desired optical transmission characteristics can be realized. On the other hand, the member having the higher refractive index than that of the glass cladding is hard to obtain sufficient mechanical strength as a fiber. Therefore, a fiber having desired optical transmission characteristics and practical strength can be prepared by the double coatings using a member having a higher refractive index for the inner coating 2 and using a member having mechanical strength necessary for the outer coating 3.

Similarly to the first embodiment, during fusion splicing of the multi-core fibers of the present embodiment, two multi-core fibers are installed such that positions of the coating markers 10 are substantially aligned, and thus complete automation alignment can be performed with the coating marker 10 as a reference using a fusion splicer.

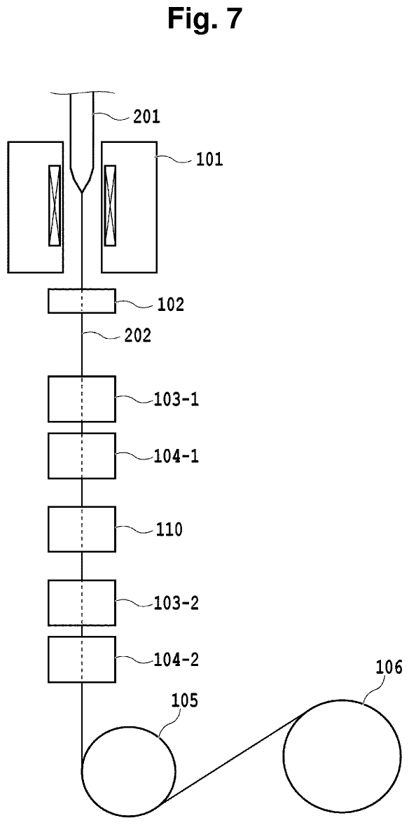

FIG. 7 shows a configuration example of a manufacturing apparatus of the multi-core fiber according to the second embodiment of the present invention. The apparatus is different from the manufacturing apparatus according to the first embodiment in that a set of a coating resin film forming unit 103-2 and a coating resin UV curing unit 104-2 is further provided between a unit 110 for drawing the coating marker and a capstan 105 to form the outer coating 3. In other words, the unit 110 for drawing the coating marker is arranged between a set of a coating resin film forming unit 103-1 and a coating resin UV curing unit 104-1 that form the inner coating 2 and the set of the coating resin film forming unit 103-2 and the coating resin UV curing unit 104-2 that form the outer coating 3. By adopting such a manufacturing configuration, it is possible to arrange the coating marker 10 between the double coatings.

### REFERENCE SIGNS LIST

1 Glass cladding

2, 3 Coating

10 Coating marker

101 Heating furnace

102 Fiber diameter monitor

103 Coating resin film forming unit

104 Coating resin UV curing unit

105, 111, 112 Capstan

106 Winding unit

110 Coating marker drawing unit

201 Multi-core fiber preform

202 Multi-core fiber

901 Cladding

902 Core

903 Marker

1. A multi-core fiber comprising:
a cladding, a plurality of cores being arranged in the same cladding; and
a coating, a marker being drawn on the coating.

2. The multi-core fiber according to claim 1, wherein the marker is drawn linearly in a longitudinal direction of the multi-core fiber.

3. The multi-core fiber according to claim 1, wherein the coating is a double coating including an inner coating and an outer coating, and the marker is drawn on the inner coating.

4. An apparatus for manufacturing a multi-core fiber, comprising:
a heating furnace;
a fiber diameter monitor;
a coating resin film forming unit;
a coating resin UV curing unit; and
a winding unit, the apparatus further comprising a unit configured to draw a coating marker on a coating formed by the coating resin film forming unit.

5. The apparatus for manufacturing a multi-core fiber according to claim 4, wherein the unit configured to draw the coating marker includes two coating marker capstans arranged to face each other so as to sandwich the multi-core fiber, and a coating material is applied to an outer peripheral surface of at least one of the coating marker capstans to draw the coating marker.

6. The apparatus for manufacturing a multi-core fiber according to claim 4, wherein
the coating resin film forming unit includes a first coating resin film forming unit and a second coating resin film forming unit,
the coating resin UV curing unit includes a first coating resin UV curing unit and a second coating resin UV curing unit, and
the unit configured to draw the coating marker is arranged between a set of the first coating resin film forming unit and the first coating resin UV curing unit and a set of the second coating resin film forming unit and the second coating resin UV curing unit.

7. The apparatus for manufacturing a multi-core fiber according to claim 5, wherein
the coating resin film forming unit includes a first coating resin film forming unit and a second coating resin film forming unit,
the coating resin UV curing unit includes a first coating resin UV curing unit and a second coating resin UV curing unit, and
the unit configured to draw the coating marker is arranged between a set of the first coating resin film forming unit and the first coating resin UV curing unit and a set of the second coating resin film forming unit and the second coating resin UV curing unit.

8. The multi-core fiber according to claim 2, wherein the coating is a double coating including an inner coating and an outer coating, and the marker is drawn on the inner coating.
